(19) United States
(12) Patent Application Publication
(10) Pub. No.: US 2014/0143755 A1
(43) Pub. Date: May 22, 2014

(54) SYSTEM AND METHOD FOR INSERTING SYNCHRONIZATION STATEMENTS INTO A PROGRAM FILE TO MITIGATE RACE CONDITIONS

(71) Applicant: NVIDIA CORPORATION, Santa Clara, CA (US)

(72) Inventors: Vinod Grover, Bellevue, WA (US); Xiangyun Kong, Santa Clara, CA (US); Jae-Woo Lee, West Lafayette, IN (US); Manjunath Kudlur, Santa Clara, CA (US); Jian-Zhong Wang, Santa Clara, CA (US)

(73) Assignee: Nvidia Corporation, Santa Clara, CA (US)

(21) Appl. No.: 13/681,554

(22) Filed: Nov. 20, 2012

(51) Int. Cl. G06F 9/44

(52) U.S. Cl. CPC G06F 8/00
USPC 717/110

(57) ABSTRACT

A system and method are provided for inserting synchronization statements into a program file to mitigate race conditions. The method includes reading a program file and determining one or more convergent statements in the program file. The method also includes inserting one or more synchronization statements in the program file between the determined convergent statements. The method further includes removing one or more of the inserted synchronization statements and writing the modified program file. The method may include, after removing the inserted synchronization statements, identifying to a user any remaining inserted synchronization statements.

### TECHNICAL FIELD

This application is directed, in general, to programming single instruction, multiple data (SIMD) processing systems and, more specifically, to a system and method, employable in conjunction with SIMD systems, for inserting barriers in program code to mitigate race conditions.

### BACKGROUND

In analytical, graphical and other processing domains, programs are often required to operate on a large collection of data points, including such collections as finite elements, an image or an audio segment. Frequently, such programs may advantageously be structured as a sequence of actions, each of which may be performed concurrently on many or all data points in the collection.

One type of processing system designed to support such programs is referred to as a SIMD system. A SIMD system provides a plurality of processors, each of which applies the instructions of the program to a single data point.

An instance of the program that is executing on a particular set of input data may be called a “thread,” and a system executing such threads may be called a single instruction, multiple thread (SIMT) system. Individual threads may be executed on different processors, which are not guaranteed to be executing the statements of the program in lock-step. That is, while a first thread may be executing a first statement in the program, a second thread may have completed the first statement and be executing a second statement of the program.

A program being executed as multiple threads may employ a shared data structure as a means of communicating information between the threads. Because the threads are not guaranteed to execute in lock-step, such communication may be foiled when a first thread gains access to an element of the data structure before or after another thread is intended to gain a conflicting access to the same element. Such a situation is referred to as a “race condition.” The occurrence of race conditions is dependent on relative execution timing between threads and, therefore, non-deterministic and difficult to reproduce and debug.

Race conditions are typically mitigated by inserting synchronization statements (also called “barriers”) into the program. When a thread reaches such a barrier statement, it pauses execution until all threads have reached the barrier. Once all threads have reached the barrier, execution of the threads has been synchronized, and all threads continue execution of subsequent statements. However, barriers affect the execution speed (or performance) of a program and may not be used appropriately by programmers, in an effort to improve performance of a program. Other programmers may simply be unaware that their code includes a potential race condition.

### SUMMARY

One aspect provides a method for inserting synchronization statements in a program file. The method includes reading a program file and determining one or more convergent statements in the program file. The method also includes inserting one or more synchronization statements in the program file between the determined convergent statements. The method further includes removing one or more of the inserted synchronization statements and writing the modified program file.

Another aspect provides a system that includes a program file database and a synchronization statement insertion tool (SSIT). The SSIT is configured to read a program file from the program file database and determine one or more convergent statements in the program file. The SSIT is also configured to insert one or more synchronization statements in the program file between the determined convergent statements. The SSIT is further configured to remove one or more of the inserted synchronization statements and write the modified program file to the program file database.

Yet another aspect provides a non-transitory, computer readable medium that stores instructions. When executed by a processing system, the instructions cause the processing system to read a program file and determine one or more convergent statements in the program file. The instructions also cause the processor to insert one or more synchronization statements in the program file between the determined convergent statements. The instructions further cause the processor to remove one or more of the inserted synchronization statements and write the modified program file.

### BRIEF DESCRIPTION

Reference is now made to the following descriptions taken in conjunction with the accompanying drawings, in which:

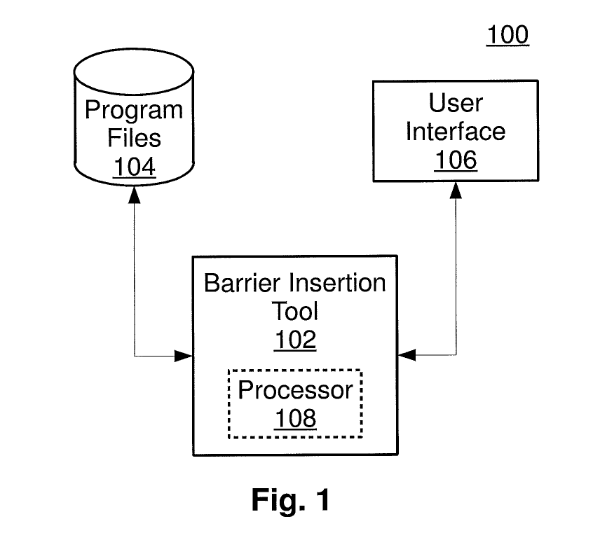

FIG. 1 is a block diagram of a barrier insertion system according to the disclosure; and

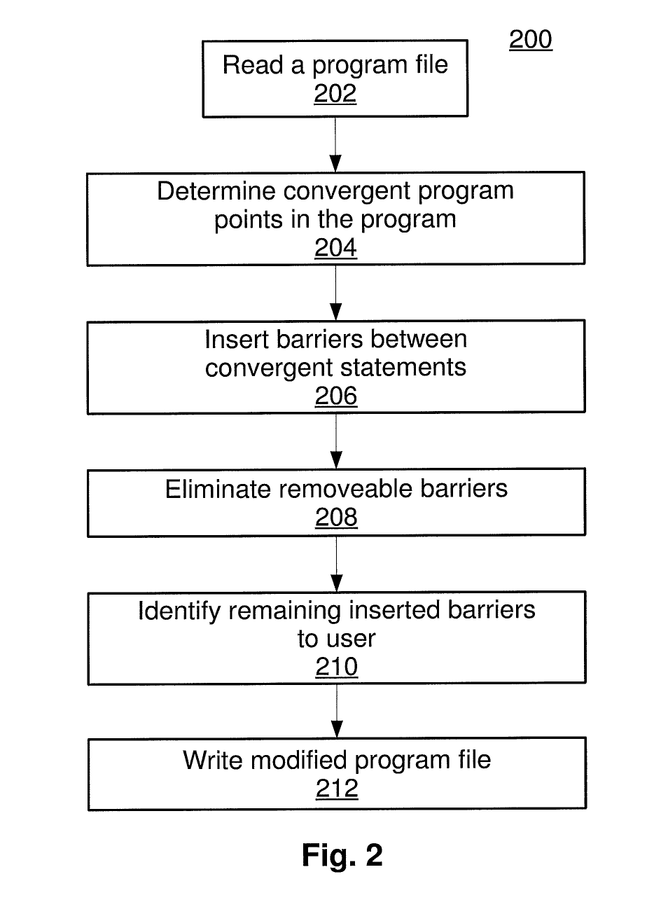

FIG. 2 is a method according to the disclosure.

### DETAILED DESCRIPTION

FIG. 1 is a block diagram of a barrier insertion system 100 (“BIS”) according to the disclosure. A barrier insertion tool 102 (“BIT”) is coupled to a program file database 104 and to a user interface 106. The BIT 102 is configured to read a SIMT program file from the database 104, insert barriers into the program file, identify inserted barriers to a user, and write the modified program file back to the database 104.

It will be understood that the BIT 102, the program file database 104, and the user interface 106 may be collocated or may be physically separated. The BIT 102, the program file database 104, and the user interface 106 may be coupled by wired or wireless communication links and may be part of a network comprising additional components not shown in FIG. 1. The BIT 102 may identify inserted barriers to the user via the user interface 106 or via the modified program file that is written to the program file database 104.

While the BIS 100 is described with reference to barrier synchronization statements, it will be understood that synchronization statements of any type may be inserted in other embodiments of the disclosure.

The BIT 102 is a processing system that includes a processor 108 and one or more subsystems (not shown) that are adapted to receive programs stored on one or more types of computer readable medium. The phrase “computer readable medium” includes any type of non-transitory medium capable of being read from or written to by a computer, such as read only memory (ROM), random-access memory (RAM), a hard disk drive, a compact disc (CD), a digital video disc or digital versatile disc (DVD), or any other type of medium. Instructions implementing part or all of one or more methods according to the disclosure may be stored on such a computer readable medium for execution by the processor of the barrier insertion tool 102.

FIG. 2 is a block diagram of a method 200 according to the disclosure. The method 200 will be described in the context of performance by the BIS 100, however, it will be understood that the method 200 may be alternatively be performed by any other suitable processing system.

In step 202, the BIT 102 reads a SIMT program file from the program file database 104. In step 204, the BIT 102 determines one or more convergent program points (or convergent statements) in the program file. In step 206, the BIT 102 inserts synchronization barrier statements between the convergent statements, where such barriers are not already present. In step 208, the BIT 102 eliminates inserted barriers that may be removed. In step 210, the BIT 102 may identify to the user any remaining barriers that the BIT 102 has inserted in the program file. In step 212, the BIT 102 writes the modified program file to the program file database 104.

In step 204, a convergent program point is defined as a statement where all threads of a Cooperative Thread Array (CTA) are guaranteed to converge if at least one of the threads reaches the statement. A program point may also be considered convergent if and only if a barrier placed at that point will never fail, that is, if either all threads will arrive at the barrier or none of the threads will arrive.

Furthermore, in step 204, one representative method for determining convergent program points is based on a characteristic known as thread variance. An instruction is thread invariant if and only if the value produced by it is independent of the thread executing it, i.e. it produces the same value for all threads. All other instructions are considered thread variant. Thread variance may arise from the access of thread id variables or from atomic instructions on shared data structures or access to volatile memory.

Any program point that is directly or indirectly control-dependent on a thread variant conditional branch cannot be considered convergent. So, one method for determining convergent program points is to remove any non-convergent program points (as just defined in the previous sentence) from the set of program points of an SIMT program and treat them as convergent. It is safe to add a barrier at such points.

In other embodiments, other suitable methods may be used for determining convergent program points.

In step 206, the method inserts a synchronization barrier at every convergent point. The method also inserts a synchronization barrier before the first statement of the program and after the last step of the program.

In step 208, the method examines each inserted barrier to determine whether the barrier may be removed. An inserted barrier cannot be removed if it acts as a barrier between (or separates) conflicting memory accesses in different threads. The memory accesses of concern are read and write operations to an address in shared memory. Where two threads gain access to the same address in shared memory, a conflicting pair of memory accesses is one where at least one of the two accesses is a write operation.

The determination of whether two threads are to gain access to the same address in shared memory may be performed by determining address expressions of a pair of potentially conflicting accesses and a size of the block of memory to which access is to be gained. If the symbolic difference of the address expressions is zero and the accessed sizes in both accesses are the same then memory accesses do not conflict and the barrier may be removed. Otherwise, a race condition between threads on the memory accesses (the memory accesses conflict), and the barrier cannot safely be removed.

A shared memory access A is said to reach a synchronization statement S from above, if during some execution of the program, A is executed followed by S, and no other synchronization statement is executed between A and S. Similarly, a shared memory access A is said to reach a synchronization statement S from below, if during some execution of the program, S is executed followed by A, and no other synchronization statement is executed between S and A.

A barrier S that is reached by no shared memory accesses from either above or below—or by no shared memory accesses from both above and below—can be removed. A barrier S that is reached only by read operations from above and below can also be removed.

In other embodiments, other suitable methods may be used for identifying inserted barriers that may safely be removed.

In step 210, the method may identify to a programmer or other user of the barrier insertion system the remaining barriers that have been inserted by the method. In some embodiments this identification comprises a line number in the program of the inserted barrier, and may also include the line numbers of the conflicting memory accesses that prevented the inserted barrier from being removed. Such line numbers may be provided to the programmer in text added to the beginning or end of the program file that is written to the program file database 104.

In other embodiments, the line numbers are displayed to the user via the user interface 106. In still other embodiments, the inserted barrier and conflicting memory accesses may be identified to the user in a program file editing program via highlighting or other such graphical indication.

In a first example, operation of the method 200 may be explained with reference to the sample program shown in Table 1.

TABLE 1

| 1 | _device_ int array[1024]; | | |
|---|---|---|---|
| 2 | _global_ void myfunc(int * result, int *y, int z) { | | |
| 3 | int x; | | |
| 4 | int tid = threadIdx.x; | | |
| 5 | x = array[tid]; | | // S1 |
| 6 | array[tid+1] = z + x; | // S2 | |
| 7 | result[tid] = (x + z) * array[tid]; | | // S3 |

| | |
|---|---|
| 8 | } |

A plurality of instances of the function myfunc are executed in parallel by a corresponding plurality of threads on a SIMT processor. Access to the data structures array (defined in line 1) and result (defined in line 2) is shared by all threads executing myfunc. In line 4, each instance of myfunc sets the internal variable tid to the value of its thread identifier. In line 5 (statement S1), the value of the element of array at address tid is read and stored in a local variable x. In line 6 (statement S2), x is added to an input parameter z and the sum is written into array at the address tid+1. In line (statement S3), the value of the element of array at address tid is read again and multiplied by the sum of x and z. The result is written into the output array result at the address tid.

The lack of synchronization barriers in myfunc, though, may result in race conditions when myfunc is executed in a SIMT processor. In a first example, because the threads executing myfunc are not executed in lock-step, statement S2 in thread 1 (writing into array[2]) may execute before statement S1 in thread 2 (reading from array[2]), thus creating unintended data flow from S2 to S1 across threads. In a second example, it may be the case that the programmer intended that statement S2 in thread 1 writes data to be read in statement S3 in thread 2, assuming a thread synchronous execution model. However, if statement S3 in thread 2 is executed before statement S2 in thread 1, the intended communication from thread 1 to thread 2 will not occur.

Step 204 of the method 200 will determine that each of the statements S1, S2 and S3 are convergent points in myfunc. Step 206 will insert a barrier call between statements S1 and S2 and between S2 and S3, as well as before the first and last statements of myfunc, statements S1 and S3. After step 206, the modified program file shown in Table 2 will result.

TABLE 2

| 1 | _device_ int array[1024]; | | |
|---|---|---|---|
| 2 | _global_ void myfunc(int * result, int *y, int z) { | | |
| 3 | int x; | | |
| 4 | int tid = threadIdx.x; | | |
| 5 | _syncthreads ( ); | | |
| 6 | x = array[tid]; | | // S1 |
| 7 | _syncthreads ( ); | | |
| 8 | array[tid+1] = z + x; | // S2 | |
| 9 | _syncthreads ( ); | | |
| 10 | result[tid] = (x + z) * array[tid]; | | // S3 |

| | |
|---|---|
| 11 | _syncthreads( ); |
| 12 | } |

Step 208 of the method 200 will remove the inserted barriers in lines 5 and 11, because they do not guard conflicting accesses across threads. The inserted barriers in lines 7 and 9, however, do guard conflicting access, in lines 6 and 8 and lines 8 and 10, respectively, and cannot be removed safely. After step 208, the final modified program file shown in Table 3 results.

TABLE 3

| 1 | _device_ int array[1024]; | | |
|---|---|---|---|
| 2 | _global_ void myfunc(int * result, int *y, int z) { | | |
| 3 | int x; | | |
| 4 | int tid = threadIdx.x; | | |
| 5 | x = array[tid]; | | // S1 |
| 6 | _syncthreads( ); | | |
| 7 | array[tid+1] = z + x; | // S2 | |
| 8 | _syncthreads( ); | | |
| 9 | result[tid] = (x + z) * array[tid]; | | // S3 |

| | |
|---|---|
| 10 | } |

In step 210, the inserted barrier at line 6 will be identified to the user as guarding conflicting memory access in lines 5 and 7. Similarly, the inserted barrier at line 8 will be identified to the user as guarding conflicting memory access in lines 7 and 9. In step 212, the modified program file shown in Table 3 is written to the program file database 104.

In a second example, operation of the method 200 may be explained with reference to the sample program shown in Table 4.

TABLE 4

| | |
|---|---|
| 1 | _global_ void kernel(int* x, int* y) |
| 2 | { |
| 3 | int index = threadIdx.x; |
| 4 | y[index] = x[index] + y[index]; |
| 5 | |
| 6 | if (index != 63 && index != 31) |
| 7 | y[index+1] = 1111; |
| 8 | } |

Again, a plurality of instances of the function kernel are executed in parallel by a corresponding plurality of threads on a SIMT processor. Access to the data structures x and y (defined in line 1) is shared by all threads executing kernel. In line 3, each instance of kernel sets the internal variable index to the value of its thread identifier. In line 4, the values of x[index] and y[index] are read, added together, and their sum written back into y[index]. In line 7, all threads except for threads with IDs 63 and 31 write the value “1111” into y[index+1].

In step 204, both lines 4 and 7 are determined to be convergent points and, after step 206, the modified program file shown in Table 5 results.

TABLE 5

| | |
|---|---|
| 1 | _global_void kernel(int* x, int* y) |
| 2 | { |
| 3 | int index = threadIdx.x; |
| 4 | _syncthreads( ); |
| 5 | y[index] = x[index] + y[index]; |
| 6 | _syncthreads( ); |
| 7 | if (index != 63 && index != 31) |
| 8 | y[index+1] = 1111; |
| 9 | _syncthreads( ); |
| 10 | } |

Step 208 of the method 200 will remove the inserted barriers in lines 4 and 9, because they do not guard conflicting accesses across threads. The inserted barriers in line 6, however, does guard conflicting access, in lines 5 and 8, and cannot be removed. After step 208, the final modified program file shown in Table 6 results.

TABLE 6

| | |
|---|---|
| 1 | _global_ void kernel(int* x, int* y) |
| 2 | { |
| 3 | int index = threadIdx.x; |
| 4 | y[index] = x[index] + y[index]; |
| 5 | _syncthreads( ); |
| 6 | if (index != 63 && index != 31) |
| 7 | y[index+1] = 1111; |
| 8 | } |

In step 210, the inserted barrier at line 5 will be identified to the user as guarding conflicting memory access in lines 4 and 7. In step 212, the modified program file shown in Table 6 is written to the program file database 104.

Those skilled in the art to which this application relates will appreciate that other and further additions, deletions, substitutions and modifications may be made to the described embodiments.

What is claimed is:

1. A method for inserting synchronization statements in a program file, the method comprising:
reading a program file;
determining one or more convergent statements in the program file;
inserting one or more synchronization statements in the program file between the determined convergent statements;
removing one or more of the inserted synchronization statements; and
writing the modified program file,
wherein at least one of the steps of reading, determining, inserting, removing, and writing is performed by a processor.

2. The method as recited in claim 1, further comprising:
after the step of removing, identifying to a user any remaining inserted synchronization statements.

3. The method as recited in claim 1, wherein said identifying comprises:
identifying a line number of the inserted synchronization statement and identifying line numbers of conflicting memory accesses separated by the inserted synchronization statement.

4. The method as recited in claim 1, wherein a convergent statement is a statement reached by all threads or by no thread, when the program file is executed on a single instruction, multiple thread processor.

5. The method as recited in claim 1, further comprising:
inserting a synchronization statement before a first statement of the program file and after a final statement of the program file.

6. The method as recited in claim 1, wherein a synchronization statement is removed if it does not separate conflicting memory accesses between threads when the program file is executed on a single instruction, multiple thread processor.

7. The method recited in claim 6, wherein conflicting memory accesses are operations that gain access to a common address in shared memory and one of the operations is a write operation.

8. A system comprising:
a program file database; and
a synchronization statement insertion tool configured to:
read a program file from the program file database;
determine one or more convergent statements in the program file;
insert one or more synchronization statements in the program file between the determined convergent statements;
remove one or more of the inserted synchronization statements; and
write the modified program file to the program file database.

9. The system as recited in claim 8, wherein the synchronization statement insertion tool is further configured to:
after removing one or more of the inserted synchronization statements, identify to a user any remaining inserted synchronization statements.

10. The system as recited in claim 9, wherein the synchronization statement insertion tool is further configured to identify an inserted synchronization statement by:
identifying a line number of the inserted synchronization statement, and
identifying line numbers of conflicting memory accesses separated by the inserted synchronization statement.

11. The system as recited in claim 8, wherein a convergent statement is a statement reached by all threads or by no thread, when the program file is executed on a single instruction, multiple thread processor.

12. The system as recited in claim 10, wherein the synchronization statement insertion tool is further configured to insert a synchronization statement before a first statement of the program file and after a final statement of the program file.

13. The system as recited in claim 7, wherein a synchronization statement is removed if it does not separate conflicting memory accesses between threads when the program file is executed on a single instruction, multiple thread processor.

14. The system as recited in claim 13, wherein conflicting memory accesses are operations that gain access to a common address in shared memory and one of the operations is a write operation.

15. A non-transitory, computer readable medium storing instructions that, when executed by a processing system, cause the processing system to insert synchronization statements in a program file by performing the steps of:
reading a program file;
determining one or more convergent statements in the program file;
inserting one or more synchronization statements in the program file between the determined convergent statements;
removing one or more of the inserted synchronization statements; and
writing the modified program file.

16. The computer readable medium as recited in claim 15, wherein the steps further comprise:
after the step of removing, identifying to a user any remaining inserted synchronization statements.

17. The computer readable medium as recited in claim 16, wherein identifying an inserted synchronization statement comprises:
identifying a line number of the inserted synchronization statement and identifying line numbers of conflicting memory accesses separated by the inserted synchronization statement.

18. The computer readable medium as recited in claim 15, wherein a convergent statement is a statement reached by all threads or by no thread, when the program file is executed on a single instruction, multiple thread processor.

19. The computer readable medium as recited in claim 15, wherein a synchronization statement is removed if it does not separate conflicting memory accesses between threads when the program file is executed on a single instruction, multiple thread processor.

20. The computer readable medium as recited in claim 15, wherein conflicting memory accesses are operations that gain access to a common address in shared memory and one of the operations is a write operation.
